(19) United States
(12) Patent Application Publication
(10) Pub. No.: US 2010/0238623 A1
(43) Pub. Date: Sep. 23, 2010

(54) Case structure for portable hard disk drive

(76) Inventor: Kang-Ping Pan, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/004,503

(22) Filed: Dec. 21, 2007

(30) Foreign Application Priority Data
Oct. 19, 2007 (TW) 96217562

(51) Int. Cl. G06F 1/16

(52) U.S. Cl. 361/679.33

(57) ABSTRACT

A case structure for portable hard disk drive includes a case integrally formed by bending a whole piece of sheet material to having a bottom, a top, a first lateral side, and a second lateral side portion. The second lateral side portion is formed by overlapping two lateral end portions of the sheet material. The case is provided at the same end of the bottom, top, and first lateral side portions with a perpendicularly inward extended stop flange each, and each of the stop flanges is further provided with an inward and perpendicularly projected hooking tab. A hard disk tray with a hard disk installed therein for receiving in the case is provided with retaining holes for engaging with the hooking tabs on the case. With the case integrally formed from one whole piece of sheet material, only one single mold is required and the scrap is largely reduced.

### RELATED APPLICATION

This application claims priority to Taiwan Application Serial Number 96217562, filed Oct. 19, 2007, which is herein incorporated by reference.

### FIELD OF THE INVENTION

The present invention relates to a case structure for portable hard disk drive, and more particularly to a portable hard disk drive case that can be formed using only one single mold and enables largely reduced scrap.

### BACKGROUND OF THE INVENTION

Generally, a portable hard disk drive includes an upper and a lower case that are respectively closed and secured to a top and a bottom of a hard disk tray using screws to protect a hard disk installed in the hard disk tray against dust, water, and/or electromagnetic wave.

These upper and lower cases are manufactured using two separate molds and therefore require increased mold cost. Moreover, a large quantity of scrap is produced in manufacturing the separated upper and lower cases to also increase the production cost of the portable hard disk drive.

It is therefore tried by the inventor to develop an improved case structure for portable hard disk drive to overcome the drawbacks in the conventional portable hard disk drive case.

### SUMMARY OF THE INVENTION

A primary object of the present invention is to provide a case structure for portable hard disk drive, so that a case of the portable hard disk drive can be integrally formed using only one single mold and at largely reduced scrap.

To achieve the above and other objects, the case structure for portable hard disk drive according to the present invention includes a case integrally formed by bending a whole piece of sheet material to having a bottom, a top, a first lateral side, and a second lateral side portion. The second lateral side portion is formed by overlapping two lateral end portions of the sheet material. The case is provided at the same one end of the bottom, top, and first lateral side portions with a perpendicularly inward extended stop flange each, and each of the stop flanges is further provided with an inward and perpendicularly projected hooking tab. And, a hard disk tray with a hard disk installed therein for receiving in the case is provided with retaining holes for engaging with the hooking tabs on the case. When the case is covered to an outer side of the hard disk tray, the hooking tabs are engaged with the retaining holes to thereby securely fix the case to the hard disk tray.

With the case integrally formed from one whole piece of sheet material, only one single mold is required and the scrap from the production of the case is largely reduced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a portable hard disk drive with a case structure according to an embodiment of the present invention;

FIG. 2 is an exploded view of FIG. 1; and

FIGS. 3a through 3e show the manner of assembling the case structure of the present invention to a hard disk and a hard disk tray of a portable hard disk drive.

### DETAILED DESCRIPTION OF THE PREFERRED EMBODIMENTS

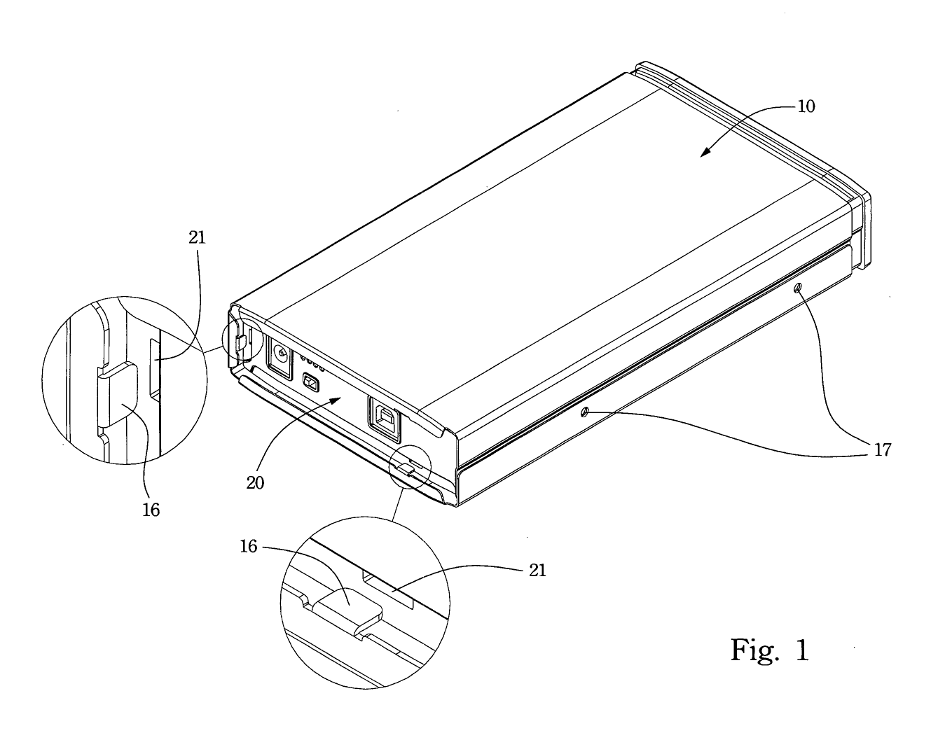

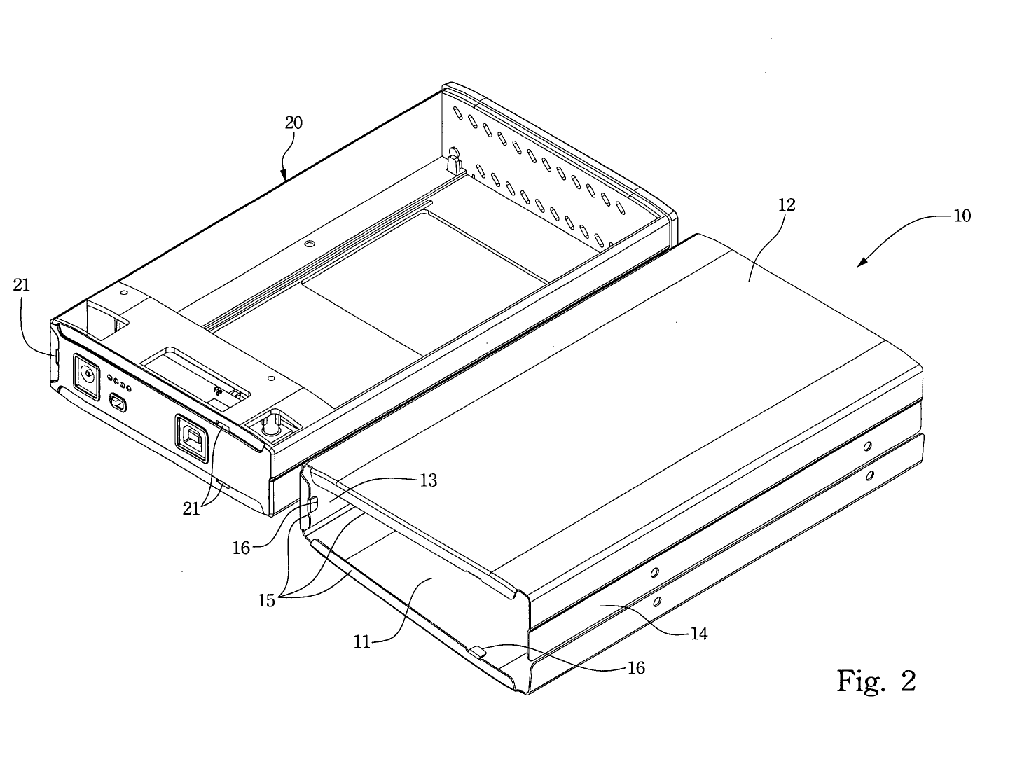

Please refer to FIGS. 1 and 2 that are assembled and exploded perspective views, respectively, of a portable hard disk drive with a case structure according to an embodiment of the present invention. As shown, the portable hard disk drive case structure of the present invention includes a case 10 integrally formed by bending a whole piece of sheet material to have a bottom portion 11, a top portion 12, a first lateral side portion 13, and a second lateral side portion 14. The second lateral side portion 14 is formed by overlapping two lateral end portions of the sheet material. The case 10 is provided at the same end of the bottom portion 11, the top portion 12, and the first lateral side portion 13 with a perpendicularly inward extended stop flange 15 each. Each of the stop flanges 15 is further provided at a predetermined position with a hooking tab 16 that is inward extended from and perpendicular to a free edge of the stop flange 15. A hard disk tray 20 to be covered by the case 10 is provided at positions corresponding to the hooking tabs 16 with a mating retaining hole 21 each.

The forming of the integral case 10 from one whole piece of sheet material requires only one single mold and enables minimized scrap. And, when the case 10 is assembled to the hard disk tray 20 to cover the latter, the hooking tabs 16 are fitly engaged with the retaining holes 21 to firmly hold the case 10 to an outer side of the hard disk tray 20.

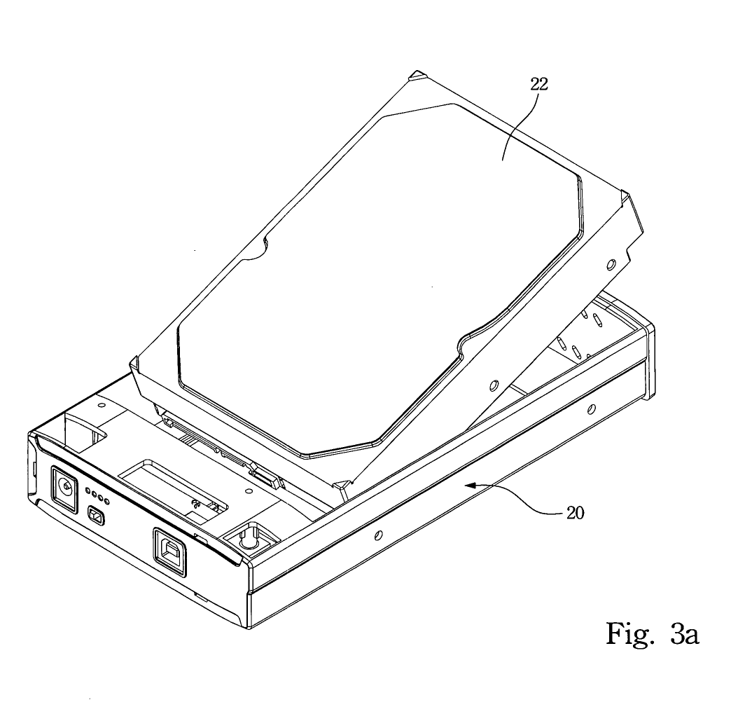

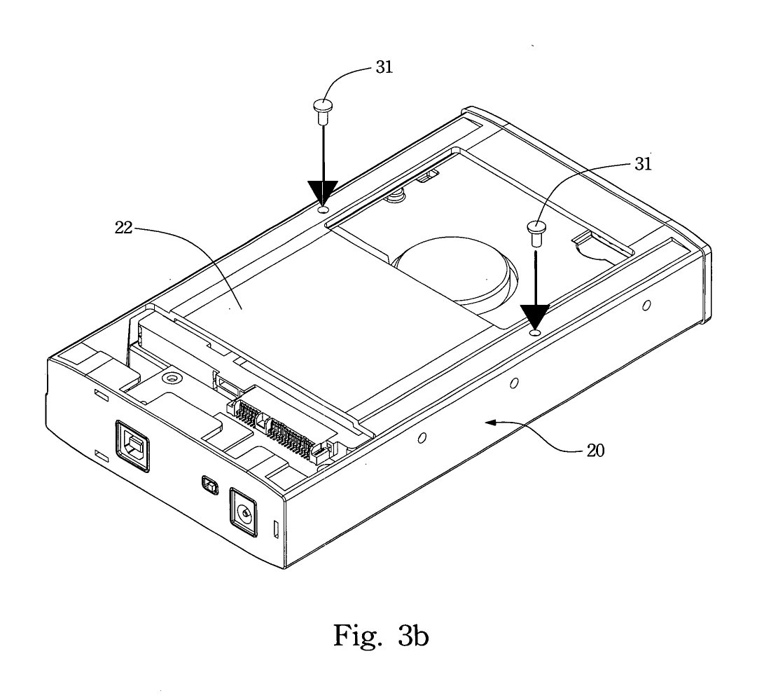

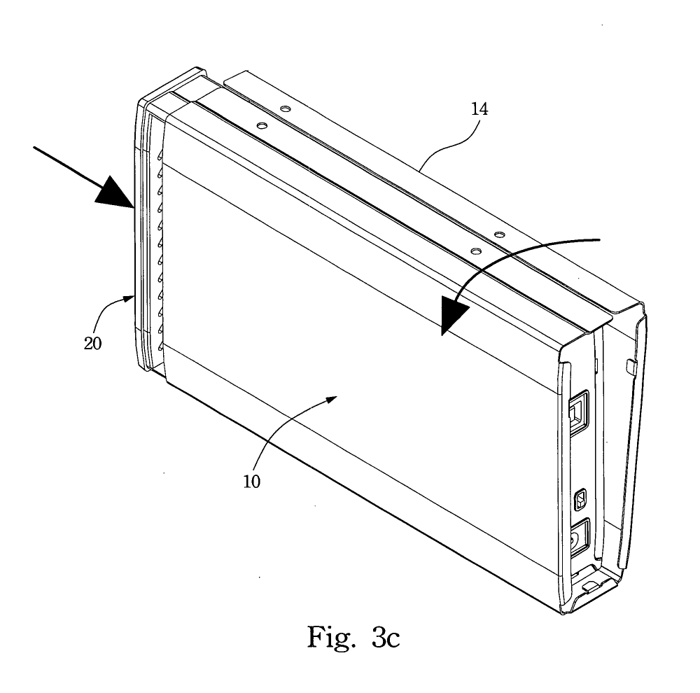

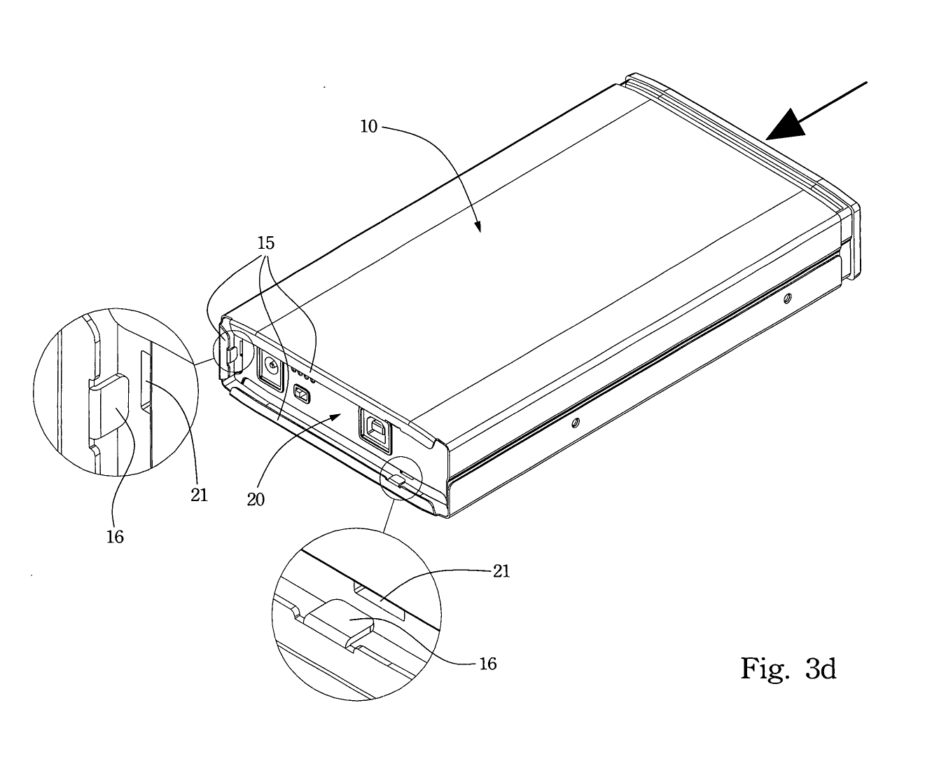

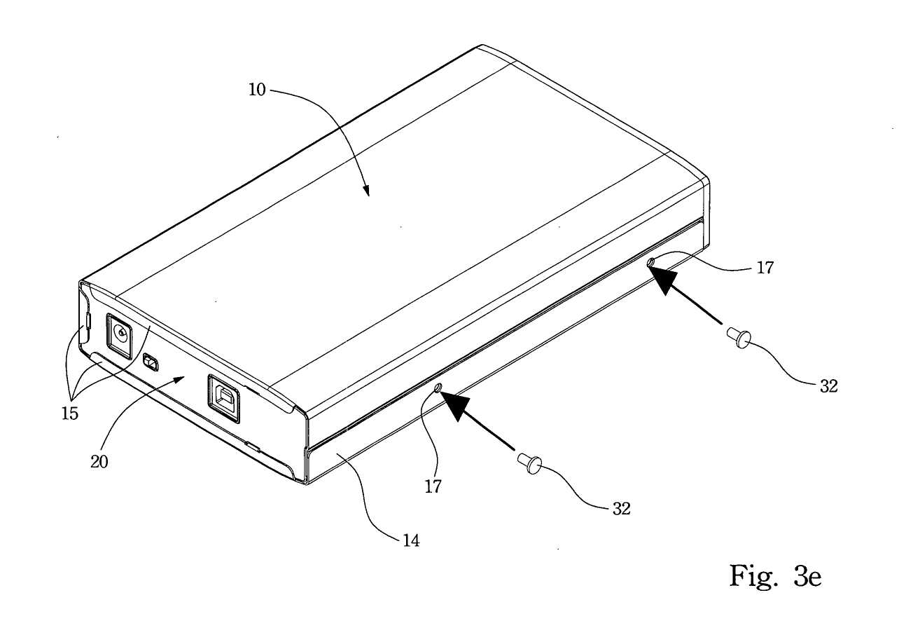

As can be seen from FIGS. 1 and 2, the second lateral side portion 14 of the case 10 is provided at predetermined positions with a plurality of through holes 17, and the hard disk tray 20 is provided at positions corresponding to the through holes 17 with a screw hole each (not shown). By extending second screws 32 through the through holes 17 to mesh with the screw holes on the hard disk tray 20 (see FIG. 3e), the case 10 may be securely covered around the hard disk tray 20.

Please refer to FIGS. 3a through 3e. Before assembling the case 10 to the hard disk tray 20, first install a hard disk 22 in the hard disk tray 20, and use first screws 31 to fasten the hard disk 22 to the hard disk tray 20, as shown in FIGS. 3a and 3b. Then, slide the case 10 onto the hard disk tray 20 from the end of the case 10 without the stop flanges 15, and press the two lateral end portions of the bent sheet material against each other to overlap the lateral end portions and thereby form the second lateral side portion 14 of the case, as shown in FIG. 3c. Thereafter, as shown in FIG. 3d, push the hard disk tray 20 further into the case 10 until a front end of the hard disk tray 20 bears against the stop flanges 15 of the case 10. At this point, the hooking tabs 16 on the case 10 are engaged with the retaining holes 21 on the hard disk tray 20, bringing the case 10 to enclose and be fixedly held to the hard disk tray 20. For the purpose of clearly showing the engagement of the case 10 with the hard disk tray 20, the hard disk tray 20 in FIG. 3d is in a position about to bear against the stop flanges 15. Finally, extend the second screws 32 through the through holes 17 on the second lateral side portion 14 of the case 10 to mesh with the screw holes correspondingly provided on the hard disk tray 20, ensuring the case 10 is securely covered around the hard disk tray 20, as shown in FIG. 3e.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A case structure for portable hard disk drive, being mounted to an outer side of a hard disk tray with a hard disk installed therein, and comprising:
a case being integrally formed by bending one whole piece of sheet material to have a bottom portion, a top portion, a first lateral side portion, and a second lateral side portion; the second lateral side portion being formed by overlapping two lateral end portions of the sheet material; the case being provided at the same end of the bottom portion, the top portion, and the first lateral side portion with a perpendicularly inward extended stop flange each; each of the stop flanges being further provided at a predetermined position with a hooking tab that is inward extended from and perpendicular to a free edge of the stop flange; and
a plurality of retaining holes being provided on the hard disk tray at positions corresponding to the hooking tabs on the case, so that the case may be covered to the outer side of the hard disk tray with the hooking tabs engaged with the retaining holes.

2. The case structure for portable hard disk drive as claimed in claim 1, wherein the second lateral side portion of the case is provided at predetermined positions with a through hole each, and the hard disk tray is provided at positions corresponding to the through holes with a screw hole each, such that a plurality of second screws may be separately extended through the through holes on the case to mesh with the screw holes on the hard disk tray.
